(19) United States
(12) Patent Application Publication
(10) Pub. No.: US 2010/0063893 A1
(43) Pub. Date: Mar. 11, 2010

(54) METHOD OF AND SYSTEM FOR SECURE ON-LINE PURCHASES

(75) Inventor: Karl Townsend, Los Altos, CA (US)

Correspondence Address: FOLEY & LARDNER LLP, 777 EAST WISCONSIN AVENUE, MILWAUKEE, WI, 53202-5306, US

(73) Assignee: Palm, Inc.

(21) Appl. No.: 12/328,654

(22) Filed: Dec. 4, 2008

Related U.S. Application Data
(63) Continuation-in-part of application No. 12/239,476, filed on Sep. 26, 2008.
(60) Provisional application No. 61/096,235, filed on Sep. 11, 2008.

(51) Int. Cl. G06Q 30/00

(52) U.S. Cl. 705/26

(57) ABSTRACT

A mobile computing device includes a display, a storage medium, and a processing circuit. The storage medium is for storing a secure element for transactions. The processing circuit is configured so that a user can purchase the product from an on-line merchant using the secure element to make an on-line payment. The mobile device can be a personal digital assistant, a handheld computer, a smart phone, a cellular phone or other computing device.

### CROSS-REFERENCE TO RELATED APPLICATIONS

This application is a continuation-in-part of prior application Ser. No. 12/239,476, filed Sep. 26, 2008, which is incorporated by reference herein in its entirety. This application claims the benefit of U.S. Provisional Application No. 61/096,235, filed Sep. 11, 2008, which is incorporated by reference herein in its entirety.

### BACKGROUND

Mobile computing devices, such as, mobile phones, handheld computers, smart phones, and personal digital assistants, can be used for various day-to-day applications. Mobile computing devices can be used to purchase goods and services via the Internet and in retail stores (e.g., brick and mortar stores).

Heretofore, customers generally utilize personal computers (or other devices capable of Internet communications) to purchase products and services via an on-line transaction. Typically, a customer can view a product or service description on-line and purchase the product or service with an on-line payment. On-line payments are typically made using credit or debit card accounts, third party payers (e.g., PayPal™), or an authorization to debit a bank or savings account.

On-line retailers can find credit card payments disadvantageous because on-line credit card transactions generally are not considered “card present” status transactions. Card present status transactions generally refer to transactions during which the retailer has the opportunity to inspect the credit card and compare identification of the purchaser and the signature of the purchaser to information on the credit card. The lack of card present status requires that the on-line retailer be responsible for fraudulent transactions and makes the retailer ineligible for a discount rate.

In addition, on-line transactions can be disadvantageous for the user because the user is often required to manually input personal information. The personal information is used to verify the authentication of the credit card as well as provide delivery information for the product and provide other market data about the user.

### SUMMARY

An exemplary embodiment relates to a mobile computing device. The mobile computing device includes a display, a storage medium, and a processing circuit. The storage medium is for storing a secure element for transactions. The processing circuit is configured so that a user can purchase the product from an on-line merchant using the secure element to make an on-line payment.

Another exemplary embodiment relates to a method of purchasing a product using a mobile computing device. The method includes providing secure element data to an on-line merchant or agent thereof, and providing an on-line payment screen for the user to approve the transaction. The secure element data is stored in storage associated with the mobile computing device. The secure element data allows the merchant or agent to obtain card present status for an on-line transaction.

Another exemplary embodiment relates to a mobile computing device. The mobile computing device includes a display and a processing circuit configured to provide an image to the display. The image includes an interface allowing the user to make an on-line purchase. The processing circuit is configured to provide credit card information stored on a secure element for the on-line purchase.

### BRIEF DESCRIPTION OF THE DRAWINGS

FIGS. 1A through 1F illustrate a mobile computing device from various views, according to an exemplary embodiment;

FIG. 2 is a block diagram of the mobile computing device of FIGS. 1A through 1F, according to an exemplary embodiment;

FIG. 3 is a block diagram of the mobile computing device illustrated in FIGS. 1 and 2 being used in a shopping application according to an exemplary embodiment;

FIG. 4 is a more detailed block diagram of the computing device including a secure element illustrated in FIG. 3 according to another exemplary embodiment;

FIG. 5 is a flow diagram showing a process for on-line shopping using the mobile computing device illustrated in FIG. 4, according to another exemplary embodiment;

FIG. 6 is a flow diagram showing a process for on-line payment in the on-line shopping process illustrated in FIG. 5, according to yet another exemplary embodiment;

FIG. 7 is a block diagram of a screen shot for the mobile computing device illustrated in FIG. 4 for use in the processes illustrated in FIGS. 5 and 6, according to an exemplary embodiment;

FIG. 8 is a flow diagram showing exemplary use scenarios of the systems and methods described herein, according to an exemplary embodiment; and

FIG. 9 is a flow diagram showing a system and method for a secure purchase, according to an exemplary embodiment.

### DETAILED DESCRIPTION OF THE EXEMPLARY EMBODIMENTS

Described herein are various exemplary embodiments of systems and methods for shopping (e.g., on-line shopping) using a mobile computing device. The mobile computing device may advantageously be configured to allow higher security for on-line transactions. Some embodiments may advantageously allow the retailer to obtain card present status for the on-line transaction, thereby qualifying for a discount rate and/or allowing the fraud obligation to transfer from the retailer to the issuing bank. A secure element can be used in some embodiments to store and provide credit card information for use in the on-line transaction. As used herein credit card information refers to credit card data, debit card data, other data associated with an account from which a purchaser can make a payment. In addition to credit card information, personal information can be provided by the mobile computing device for the transaction. Still another embodiment uses near field communication (“NFC”) circuitry to allow the mobile device to be used as a credit card at point-of-sale (“POS”) terminals. POS terminals include service terminals such as mass transit systems, parking systems, etc. Thus, embodiments described herein may use a mobile computing device to make the on-line shopping experience (as well as traditional shopping experience) easier and/or less costly to the merchant or user.

Embodiments described herein may allow a retailer to achieve card present status for on-line transactions. Further, embodiments may make on-line credit card transactions easier and more secure for the retailer and the purchaser. Further still, embodiments may configure a mobile computing device for secure on-line credit card transactions and/or simplified on-line credit card transactions.

The teachings herein extend to those embodiments that fall within the scope of the appended claims, regardless of whether they accomplish one or more of the above-mentioned exemplary advantages.

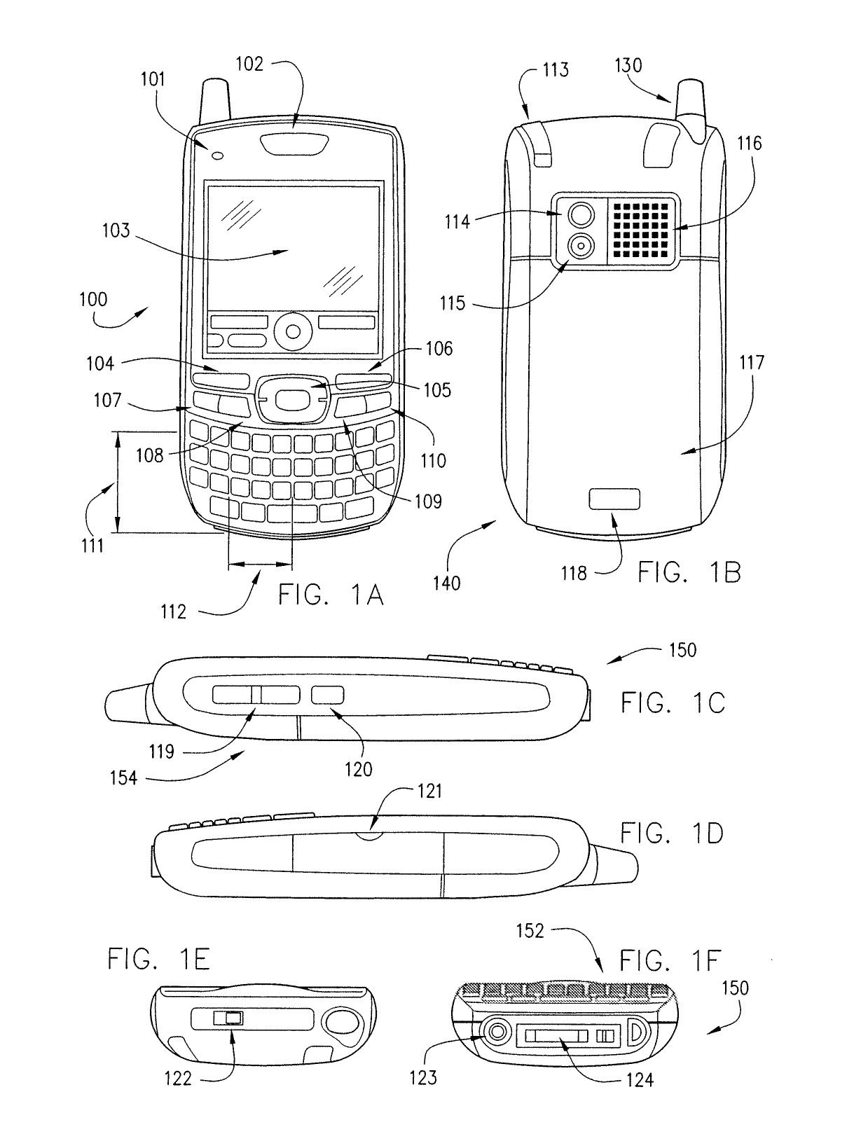

Referring to FIGS. 1A through 1F, a mobile computing device 100 is shown from various angles, according to an exemplary embodiment. FIG. 1A is a front view of device 100; FIG. 1B is a rear view of device 100; FIGS. 1C and 1D are side views of device 100; and FIGS. 1E and 1F are top and bottom views of device 100. The device may be any type of communications or computing device (e.g., a cellular phone, other mobile device, digital media player (e.g., audio or audio/video), personal digital assistant, etc.).

Device 100 may be a smart phone, which is a combination mobile telephone and handheld computer having personal digital assistant (“PDA”) functionality. The teachings herein can be applied to other mobile computing devices (e.g., a laptop computer) or other electronic devices (e.g., a desktop personal computer, etc.). PDA functionality can comprise one or more of personal information management, database functions, word processing, spreadsheets, voice memo recording, location-based services, device backup and lock, media playing, Internet browsing, etc. and is configured to synchronize, publish/subscribe, download, or otherwise communicate personal information or user data (e.g., contacts, e-mail, calendar, notes, to-do list, web browser favorites, etc.) from one or more applications with a computer (e.g., desktop, laptop, server, etc.). Device 100 is further configured to receive and operate additional applications provided to device 100 after manufacture, e.g., via wired or wireless download, Secure Digital card, etc. Device 100 can be configured to utilize a secure element to achieve a secure on-line transaction.

Device 100 may be a handheld computer (e.g., a computer small enough to be carried in a typical front pocket found in a pair of pants, purse or other similar pocket), comprising such devices as typical mobile telephones and PDAs, but the term “handheld” and the phrase “configured to be held in a hand during use” excluding typical laptop computers and tablet personal computers (“PCs”) for purposes of this disclosure. In alternative embodiments, the teachings herein may extend to laptop computers, tablet PCs, desktop PCs, and other electronic devices. The various input devices and other parts of device 100 as described below may be positioned anywhere on device 100 (e.g., the front side of FIG. 1A, the rear side of FIG. 1B, the sides of FIGS. 1C and 1D, on a keyboard which is retractable to slide in and out from a portion of device 100 to be revealed along any of the sides of device 100, etc.).

Device 100 includes various user input devices. For example, the user input devices may include a send button 104 usable to select options appearing on display 103 and/or send messages, a 5-way navigator 105 usable to navigate through options appearing on display 103, a power/end button 106 usable to select options appearing on display 103 and to turn on display 103, a phone button 107 usable to access a phone application screen, a calendar button 108 usable to access a calendar application screen, a messaging button 109 usable to access a messaging application screen (e.g., e-mail, text, Multimedia Messaging Service (MMS), etc.), an applications button 110 usable to access a screen showing available applications, a thumb keyboard 111 (which includes a phone dial pad 112 usable to dial during a phone application), a volume button 119 usable to adjust the volume of audio output of device 100, a customizable button 120 which a user may customize to perform various functions, a ringer switch 122 usable to switch the device from one mode to another mode (such as switching from a normal ringer mode to a meeting ringer mode), and a touch screen display 103 usable to select control options displayed on display 103. Touch screen display 103 may comprise a capacitive touch screen, a mutual capacitance touch screen, a self capacitance touch screen, a resistive touch screen, a touch screen using cameras and light such as a surface multi-touch screen, proximity sensors, or other touch screen technologies. Touch screen display 103 may be configured to receive inputs from finger touches at a plurality of locations on display 103 at the same time. Touch screen display 103 may be configured to receive a finger swipe or other directional input, which may be interpreted by a processing circuit to control certain functions distinct from a single touch input. For example, the finger swipe can be utilized to authorize a secure credit card transaction. The credit card action can be an on-line transaction or a brick and mortar transaction using NFC, RFID, or other communication technologies. Alternatively, touch screen display 103 can provide entry of a password or a specific button for authorizing credit card transactions. NFC may be a short-range, high frequency wireless communication technology which enables the exchange of data between devices over a short distance, such as about 10 centimeters, or less than 20 centimeters. A secure element using NFC may use magnetic field induction for communication, for example using a loop antenna to communicate with another loop antenna in the target device with which the secure element is communicating, which effectively provides an air core transformer. A secure element using NFC may operate in a passive communication mode, in which the target device acts as a transponder, drawing power from a received NFC signal and/or modulating the existing carrier field to provide response data. For example, an NFC reader can provide power through its loop antenna to an NFC-enabled mobile device and thereby power the NFC receiver and secure element in the mobile device. Alternatively, the secure element may operate in an active communication mode, in which a device deactivates its own field while awaiting a response and/or both the secure element and the target device are independently powered. For example, in an active communication mode, an NFC passive device can receive power from the NFC communication (via a loop antenna) and independently power its own NFC chip or RFID tag. A secure element integrated circuit (IC) manufactured by Infineon Technologies AG may be used, in one exemplary embodiment. As other examples, an NFC IC manufactured by NXP Semiconductors, The Netherlands, STMicroelectronics, Geneva, Switzerland, or Texas Instruments Incorporated, Dallas, Tex. may be used.

Device 100 also includes various audio circuits. The audio circuits may include phone speaker 102 usable to listen to information in a normal phone mode, external speaker 116 louder than the phone speaker (e.g. for listening to music, for a speakerphone mode, etc.), headset jack 123 to which a user can attach an external headset which may include a speaker and/or a microphone, and a microphone that can be used to pick up audio information such as the user's end of a conversation during a phone call.

Device 100 may also include a status indicator 101 that can be used to indicate the status of device 100 (such as messages pending, charging, low battery, etc.), a stylus slot 113 for receiving a stylus usable to input data on touch screen display 103, a digital camera 115 usable to capture images, a mirror 114 positioned proximate camera 115 such that a user may view themselves in mirror 114 when taking a picture of themselves using camera 115, a removable battery 118, and a connector 124 which can be used to connect device 100 to either (or both) an external power supply such as a wall outlet or battery charger or an external device such as a personal computer, a global positioning system (“GPS”) unit, a display unit, or some other external device. Camera 115 can be used to capture product codes, (e.g., UPC bar codes). Alternatively, device 100 can include a scanner or bar code reader for capturing product codes.

Device 100 may also include an expansion slot 121 that may be used to receive a memory card and/or a device which communicates data through slot 121, and a Subscriber Identity Module (SIM) card slot 117, located behind battery 118, configured to receive a SIM card or other card that allows the user to access a cellular network.

In various embodiments device 100 may include a housing 140. Housing 140 may be configured to retain or secure a screen in a fixed relationship above a plurality of user input devices in a substantially parallel or same plane. A fixed relationship may exclude a hinged or movable relationship between the screen and plurality of keys in the fixed embodiment, though hinged or movable relationships may be used in other embodiments.

In various embodiments device 10, 600 may include a housing 640. Housing 640 could be any size, shape, and dimension. In some embodiments, housing 640 has a width 652 (shorter dimension) of no more than about 200 mm or no more than about 100 mm, or a width 652 of at least about 30 mm or at least about 50 mm. In some embodiments, housing 640 has a length 654 (longer dimension) of no more than about 200 mm or no more than about 150 mm, or a length 654 of at least about 70 mm or at least about 100 mm. In some embodiments, housing 640 has a thickness 650 (smallest dimension) of no more than about 150 mm or no more than about 50 mm, or a thickness 650 of at least about 10 mm or at least about 15 mm. In some embodiments, housing 640 has a volume of up to about 2500 cubic centimeters and/or up to about 1500 cubic centimeters.

Device 100 may include an antenna 130 system for transmitting and/or receiving radio frequency signals. Each transceiver of device 100 may include individual antennas or may include a common antenna 130. The antenna system may include or be implemented as one or more internal antennas and/or external antennas.

While described with regards to a handheld device, many embodiments are usable with portable devices which are not handheld and/or with non-portable devices/systems.

Device 100 may provide voice communications functionality in accordance with different types of cellular radiotelephone systems. Examples of cellular radiotelephone systems may include Code Division Multiple Access (“CDMA”) cellular radiotelephone communication systems, Global System for Mobile Communications (“GSM”) cellular radiotelephone systems, etc.

In addition to voice communications functionality, device 100 may be configured to provide data communications functionality in accordance with different types of cellular radiotelephone systems. Examples of cellular radiotelephone systems offering data communications services may include GSM with General Packet Radio Service (“GPRS”) systems (“GSM/GPRS”), CDMA/1xRTT (1 times Radio Transmission Technology) systems, Enhanced Data Rates for Global Evolution (“EDGE”) systems, Evolution Data Only or Evolution Data Optimized (“EV-DO”) systems, etc.

Device 100 may be configured to provide voice and/or data communications functionality through wireless access points (“WAPs”) in accordance with different types of wireless network systems. A wireless access point may comprise any one or more components of a wireless site used by device 100 to create a wireless network system that connects to a wired infrastructure, such as a wireless transceiver, cell tower, base station, router, cables, servers, or other components depending on the system architecture. Examples of wireless network systems may further include a wireless local area network (“WLAN”) system, wireless metropolitan area network (“WMAN”) system, wireless wide area network (“WWAN”) system (e.g., a cellular network), and so forth. Examples of suitable wireless network systems offering data communication services may include the Institute of Electrical and Electronics Engineers (“IEEE”) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, a wireless personal area network (“PAN”) system, such as a Bluetooth® system operating in accordance with the Bluetooth Special Interest Group (“SIG”) series of protocols.

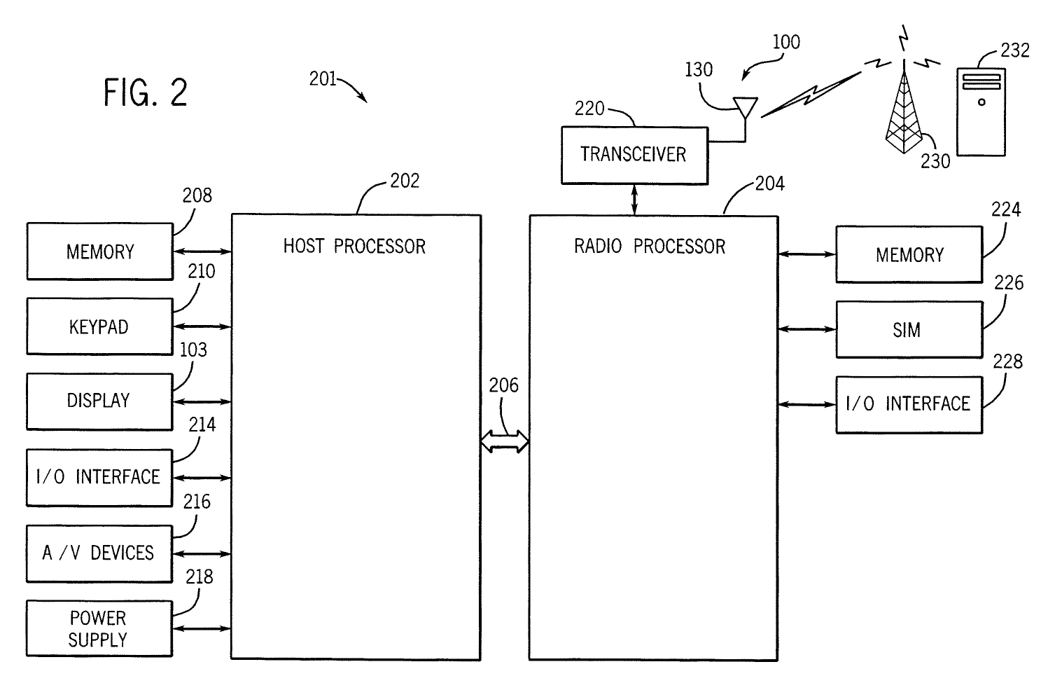

As shown in the embodiment of FIG. 2, device 100 comprises a processing circuit 201, which may comprise a dual processor architecture, including a host processor 202 and a radio processor 204 (e.g., a base band processor or modem). Host processor 202 and radio processor 204 may be configured to communicate with each other using an interface 206 such as one or more universal serial bus (“USB”) interfaces, micro-USB interfaces, universal asynchronous receiver-transmitter (“UART”) interfaces, general purpose input/output (“GPIO”) interfaces, control/status lines, control/data lines, shared memory, and so forth. Radio processor 204 can also be used for near field communications (“NFC”) such as, for using device 100 as a credit card near a POS terminal. Alternatively, a separate NFC circuit can be provided.

Host processor 202 may be configured to execute various computer programs (e.g., software, firmware, or other code) such as application programs and system programs to provide computing and processing operations for device 100. Radio processor 204 may be responsible for performing various voice and data communications operations for device 100 such as transmitting and receiving voice and data information over one or more wireless communications channels. Although embodiments of the dual processor architecture may be described as comprising host processor 202 and radio processor 204 for purposes of illustration, the dual processor architecture of device 100 may comprise one processor, more than two processors, may be implemented as a dual- or multi-core chip with both host processor 202 and radio processor 204 on a single chip, etc. Alternatively, a single processor or multiple processors may perform the functions of host processor 202 and radio processor 204, such as a single, unified processor that handles host and radio functions, or other multiprocessor topologies which do not rely on the concept of a host. Alternatively, processing circuit 201 may comprise any digital and/or analog circuit elements, comprising discrete and/or solid state components, suitable for use with the embodiments disclosed herein.

In various embodiments, host processor 202 may be implemented as a host central processing unit (“CPU”) using any suitable processor or logic device, such as a general purpose processor. Host processor 202 may comprise, or be implemented as, a chip multiprocessor (“CMP”), dedicated processor, embedded processor, media processor, input/output (“I/O”) processor, co-processor, field programmable gate array (“FPGA”), programmable logic device (“PLD”), or other processing device in alternative embodiments.

Host processor 202 may be configured to provide processing or computing resources to device 100. For example, host processor 202 may be responsible for executing various computer programs such as application programs and system programs to provide computing and processing operations for device 100. Examples of application programs may include, for example, a telephone application, voicemail application, e-mail application, instant message (“IM”) application, short message service (“SMS”) application, multimedia message service (“MMS”) application, web browser application, personal information manager (“PIM”) application (e.g., contact management application, calendar application, scheduling application, task management application, web site favorites or bookmarks, notes application, etc.), word processing application, spreadsheet application, database application, video player application, audio player application, multimedia player application, digital camera application, video camera application, media management application, a gaming application, and so forth. The application software may provide a graphical user interface (“GUI”) to communicate information between device 100 and a user. The computer programs may be stored as firmware on a memory associated with processor 202, may be loaded by a manufacturer during a process of manufacturing device 100, and may be updated from time to time with new versions or software updates via wired or wireless communication.

System programs assist in the running of a computer system. System programs may be directly responsible for controlling, integrating, and managing the individual hardware components of the computer system. Examples of system programs may include, for example, an operating system (“OS”), a kernel, device drivers, programming tools, utility programs, software libraries, an application programming interface (“API”), a GUI, and so forth. Device 100 may utilize any suitable OS in accordance with the described embodiments such as a Palm OS®, Palm OS® Cobalt, Microsoft Windows® OS, Microsoft Windows®, Microsoft Pocket PC, Microsoft Mobile, Symbian OS™, Embedix OS, any Linux distribution, Binary Run-time Environment for Wireless (“BREW”) OS, JavaOS, a Wireless Application Protocol (“WAP”) OS, and so forth.

Device 100 may comprise a memory 208 coupled to host processor 202. In various embodiments, memory 208 may be configured to store one or more computer programs to be executed by host processor 202. Memory 208 may be implemented using any machine-readable or computer-readable media capable of storing data such as volatile memory or non-volatile memory, removable or non-removable memory, erasable or non-erasable memory, writeable or re-writeable memory, and so forth. Examples of machine-readable storage media may include, without limitation, random-access memory (“RAM”), dynamic RAM (“DRAM”), Double-Data-Rate DRAM (“DDRAM”), synchronous DRAM (“SDRAM)”, static RAM (“SRAM”), read-only memory (“ROM”), programmable ROM (“PROM”), erasable programmable ROM (“EPROM”), electrically erasable programmable ROM (“EEPROM”), flash memory (e.g., NOR or NAND flash memory), or any other type of media suitable for storing information. Memory 208 can be used to store credit card information and personal information for on-line and brick and mortar retail transactions.

Although memory 208 is shown as being separate from host processor 202 for purposes of illustration, in various embodiments some portion or the entire memory 208 may be included on the same integrated circuit as host processor 202. Alternatively, some portion or the entire memory 208 may be disposed on an integrated circuit or other medium (e.g., hard disk drive) external to the integrated circuit of host processor 202. In various embodiments, device 100 may comprise a memory port or expansion slot 121 (shown in FIG. 1) to support a multimedia and/or memory card, for example. Processing circuit 201 may use memory port or expansion slot 121 to read and/or write to a removable memory card having memory, for example, to determine whether a memory card is present in port or slot 121, to determine an amount of available memory on the memory card, to store subscribed content or other data or files on the memory card, etc.

Memory 100 preferably stores secure element data associated with credit card information. The secure element data is preferably used by device 200 to make an on-line purchase via the Internet or a website. The secure element data allows card present status to be achieved as the user orders a product on-line using device 100. Advantageously, device 100 including secure element data can provide the unique value that a conventional PC cannot offer. Using device 100 with the secure element data allows card present status to be achieved for an on-line transaction via the Internet capabilities of device 100, thereby allowing the on-line transaction to qualify for a discount rate and transferring the fraud obligation to the retailer to the issuing bank. When a user makes a credit card transaction, processor 202 can utilize information stored in memory 100 (e.g., preferably stored via secure element data) to automatically input credit card and personal information for the transaction. In this way, device 100 implements a secure web-enabled system that bypasses the manual entry of credit card and personal information. This provides a significant advantage over utilizing auto-fill capabilities because device 100 securely communicates with the retailers transaction system through the Internet to authorize the payment. The user does not have to enter his or her personal information or credit card information because device 100 operates as an authorized credit card. With device 100, the user need not carry the credit card. In some embodiments, a password or finger swipe can be required to authorize the credit card transaction. Accordingly, device 100 with secure element data simplifies the on-line transaction.

Device 100 may comprise a user input device 210 coupled to the host processor 202. User input device 210 may comprise, for example, a alphanumeric, numeric or QWERTY key layout and an integrated number dial pad. Device 100 also may comprise various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, a keypad and so forth. Examples of such objects are shown in FIG. 1 as 5-way navigator 105, power/end button 106, phone button 107, calendar button 108, messaging button 109, applications button 110, thumb keyboard 111, volume button 119, customizable button 120, and ringer switch 122. A button can be programmed to provide authorization for NFC credit card transactions and/or on-line credit card transactions.

Host processor 202 may be coupled to display 103. Display 103 may comprise any suitable visual interface for displaying content to a user of device 100. For example, display 103 may be implemented by a liquid crystal display (“LCD”) such as a touch-sensitive color (e.g., 16-bit color) thin-film transistor (“TFT”) LCD screen. In some embodiments, the touch-sensitive LCD may be used with a stylus and/or a handwriting recognizer program. The handwriting recognizer program can be configured to verify a signature provided on display 103 for certain applications, such as authorizing credit card transactions.

Device 100 may comprise an I/O interface 214 coupled to the host processor 202. I/O interface 214 may comprise one or more I/O devices such as a serial connection port, an infrared port, integrated Bluetooth® wireless capability, and/or integrated 802.11x (WiFi) wireless capability, to enable wired (e.g., USB cable) and/or wireless connection to a local computer system, such as a PC, or a remote computer system, such as a computer server. In various implementations, device 100 may be configured to transfer and/or synchronize information with the local computer system, such as personal information management data stored in one or more databases in memory 208.

Host processor 202 may be coupled to various audio/video (“A/V”) devices 216 that support A/V capability of device 100. Examples of A/V devices 216 may include, for example, a microphone, one or more speakers, an audio port to connect an audio headset, an audio coder/decoder (codec), an audio player, a digital camera, a video camera, a video codec, a video player, and so forth.

Host processor 202 may be coupled to a power supply 218 configured to supply and manage power to the elements of device 100. In various exemplary embodiments, power supply 218 may be implemented by a rechargeable battery, such as a removable and rechargeable lithium ion battery to provide direct current (“DC”) power, and/or an alternating current (“AC”) adapter to draw power from a standard AC main power supply.

As mentioned above, radio processor 204 may perform voice and/or data communication operations for device 100. For example, radio processor 204 may be configured to communicate voice information and/or data information over one or more assigned frequency bands of a wireless communication channel. Radio processor 204 may be implemented as a communications processor using any suitable processor or logic device, such as a modem processor or baseband processor. Radio processor 204 may comprise, or be implemented as, a digital signal processor (“DSP”), a media access control (“MAC”) processor, or any other type of communications processor in accordance with the described embodiments. Radio processor 204 may be any of a plurality of modems manufactured by Qualcomm, Inc. or other manufacturers.

Device 100 may comprise a transceiver 220 coupled to radio processor 204. Transceiver 220 may comprise one or more transceivers configured to communicate using different types of protocols, communication ranges, operating power requirements, RF sub-bands, information types (e.g., voice or data), use scenarios, applications, and so forth. For example, transceiver 220 may comprise a Wi-Fi transceiver and a cellular or WAN transceiver configured to operate simultaneously.

Transceiver 220 may be implemented using one or more chips as desired for a given implementation. Although transceiver 220 is shown as being separate from and external to radio processor 204 for purposes of illustration, in various embodiments some portion or the entire transceiver 220 may be included on the same integrated circuit as radio processor 204.

Device 100 may comprise an antenna or antenna system 130 for transmitting and/or receiving electrical signals. As shown, antenna system 130 may be coupled to radio processor 204 through transceiver 220. Radio tower 230 and server 232 are shown as examples of potential objects configured to receive a signal from antenna system 130.

Device 100 may comprise a memory 224 coupled to radio processor 204. Memory 224 may be implemented using any type of memory described with reference to memory 208. Although memory 224 is shown as being separate from and external to radio processor 204 for purposes of illustration, in various embodiments some portion or the entire memory 224 may be included on the same integrated circuit as radio processor 204. Further, host processor 202 and radio processor 204 may share a single memory.

Device 100 may comprise a SIM 226 coupled to radio processor 204. SIM 226 may comprise, for example, a removable or non-removable smart card configured to encrypt voice and data transmissions and to store user-specific data for allowing a voice or data communications network to identify and authenticate the user. SIM 126 also may store data such as personal settings specific to the user.

Device 100 may comprise an I/O interface 228 coupled to the radio processor 204. I/O interface 228 may comprise one or more I/O devices to enable wired (e.g., serial, cable, etc.) and/or wireless (e.g., WiFi, short range, etc.) communication between device 100 and one or more external computer systems.

In various embodiments, device 100 may comprise location or position determination capabilities. Device 100 may employ one or more position determination techniques including, for example, GPS techniques, Cell Global Identity (“CGI”) techniques, CGI including timing advance (“TA”) techniques, Enhanced Forward Link Trilateration (“EFLT”) techniques, Time Difference of Arrival (“TDOA”) techniques, Angle of Arrival (“AOA”) techniques, Advanced Forward Link Trilateration (“AFTL”) techniques, Observed Time Difference of Arrival (“OTDOA”), Enhanced Observed Time Difference (“EOTD”) techniques, Assisted GPS (“AGPS”) techniques, hybrid techniques (e.g., GPS/CGI, AGPS/CGI, GPS/AFTL or AGPS/AFTL for CDMA networks, GPS/EOTD or AGPS/EOTD for GSM/GPRS networks, GPS/OTDOA or AGPS/OTDOA for UMTS networks), etc. Position determination techniques may be based on signals from one or more nearby cellular towers, one or more Wi-Fi access points (in which position is determined at least in part by collecting addresses of nearby wireless access points and comparing the addresses to a pre-stored database which associates addresses to geographic position), or other techniques.

In various embodiments, device 100 may comprise dedicated hardware circuits or structures, or a combination of dedicated hardware and associated software, to support position determination. For example, transceiver 220 and antenna system 130 may comprise GPS receiver or transceiver hardware and one or more associated antennas coupled to radio processor 204 to support position determination.

Host processor 202 may comprise and/or implement at least one location-based service (“LBS”) application. In general, the LBS application may comprise any type of client application executed by host processor 202, such as a GPS application configured to communicate position requests (e.g., requests for position fixes) and position responses. Examples of LBS applications include, without limitation, wireless 911 emergency services, roadside assistance, asset tracking, fleet management, friends and family locator services, dating services, and navigation services which may provide the user with maps, directions, routing, traffic updates, mass transit schedules, information regarding local points-of-interest (“POI”) such as restaurants, hotels, landmarks, and entertainment venues, and other types of LBS services in accordance with the described embodiments.

Radio processor 204 may be configured to generate a position fix by configuring a position engine and requesting a position fix. For example, a position engine interface on radio processor 204 may set configuration parameters that control the position determination process. Examples of configuration parameters may include, without limitation, location determination mode (e.g., standalone, Mobile Station-assisted, Mobile Station-based), actual or estimated number of position fixes (e.g., single position fix, series of position fixes, request position assist data without a position fix), time interval between position fixes, Quality of Service (“QoS”) values, optimization parameters (e.g., optimized for speed, accuracy, or payload), Position Determination Entity address (e.g., IP address and port number of LPS or MPC), etc. In one embodiment, the position engine may be implemented as a QUALCOMM® gpsOne® engine.

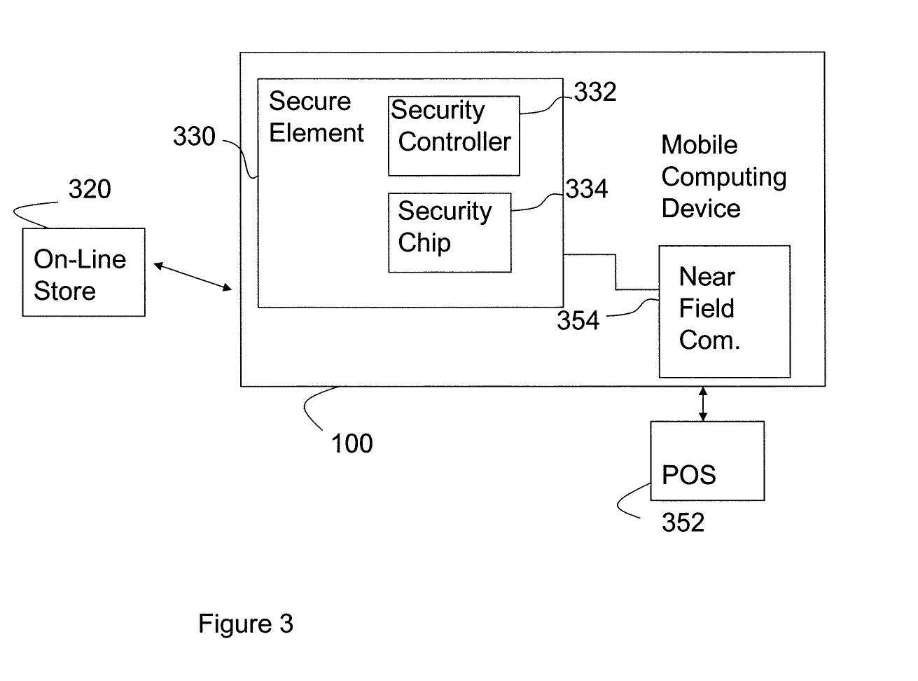

Referring to FIG. 3, mobile computing device 100 can be utilized in a retail environment or on-line environment to advantageously assist the shopping experience. In a preferred embodiment, mobile computing device 100 can be utilized to make a purchase at an on-line store 330 via the world wide web or Internet, or other network.

According to another embodiment, a customer has a mobile computing device 100, such as a TREO™ device and is shopping in a location in a store, such as a retail store. The buyer can purchase at a retail store using near field communication (NFC) circuit 354 at a POS terminal 352. In one example, a user may swipe device 100 near or in contact with POS terminal 352, allowing NFC circuits in device 100 and terminal 352 to identify each other wirelessly and communicate personal information from device 100 to terminal 352 needed to make a purchase.

In one embodiment, mobile computing device 100 includes a separate secure element circuit 330 including a security controller 332 and a security chip 334. Secure element circuit 330 is a module that ensures that payment information is securely communicated for purchases using mobile computing device 100.

Security controller 332 preferably allows device 100 to make a payment to on-line store 320 utilizing credit card information stored in security chip 334. Secure element 330 can also be coupled to near field communication circuit 354 for providing credit card information to POS terminal 352. Secure element 330 can be integrated within mobile computing device 100 or alternatively be provided on a SIM card, a secure flash card, etc.

Preferably, host processor 202 is configured to provide all secure transactions through secure element 330. Secure element 330 via security controller 332 can provide encryption and decryption capabilities.

A credit agency or company (e.g., a bank, credit union, or other financial institution) issuing a credit card or credit number may be under contract with a manufacturer of device 100 and one or more retailers wherein “card present” status is provided contractually to the retailer when device 100 having secure element 330 is used for a purchase. The credit agency may provide a lower fee to the retailer and/or owner of device 100 based on the “card present” determination (e.g., a reduction in the fee of 1.5%, at least 0.1%, at least 1%, etc.). The fee is typically measured as a percentage of the transaction price, but may alternatively be a flat fee or other fee arrangement. Further, the credit agency may provide (e.g., contractually) a shift in the liability for fraudulent purchases from the retailer to the credit agency based on the “card present” determination.

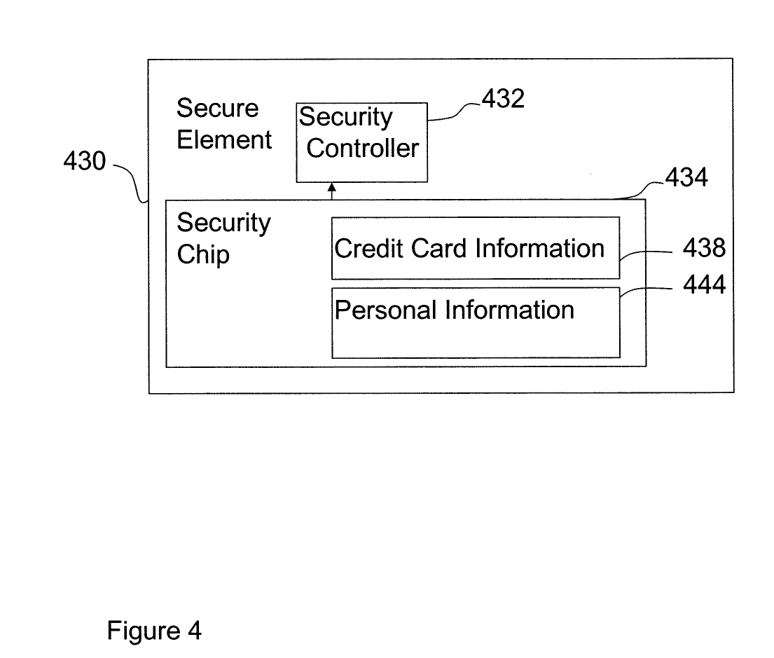

With reference to FIG. 4, security chip 434 can include a storage area for credit card information 438 and personal information 444. Credit card information 438 can include credit card numbers as well as other credit card data. The credit card numbers can include a six digit issuer identification number (e.g., a bank number), the individual account number, the expiration date, a check digit, etc. In addition, NCVV/CVC codes or other control or verification codes can be stored. Security chip 434 can further store personal information 444. Alternatively, the personal information 444 can be stored in or near memory 224 of device 100. The personal information can include name, residence address (e.g., including zip code), preferred delivery address, preferred mode of delivery (next day, US Post Office, ground, etc.), business or personal purchase, etc. The connection to the Internet can be made via a wireless connection associated with device 100.

Mobile computer 100 preferably can provide a remotely or internally stored buyer's profile, any portion of which may be transmitted to a retailer for the purpose of making a purchase, either before a specific purchase to create and account or along with credit card information when making a purchase. The buyer's profile can include personal information such as residential or business addresses, shipping addresses and on-line payment information. In addition, the buyer's profile can indicate the type of buyer the customer is and can include a history of previous payments and classifications of the buyer as a heavy user of a particular store or type of products. Such information may be useful by retailers, either on-line or traditional brick and mortar retailers, for determining what type of discounts the buyer may qualify for based on past purchases. The buyer's profile information can allow an on-line retailer to quote exact pricing with shipping. The buyer's profile may also include buying and shopping habits or history with the retailer and/or similar retailers, real-time credit rating, preferred shipping address, etc. Therefore, an on-line merchant might give a potential buyer a price or other payment term based at least in part on one or more components of the buyer's profile.

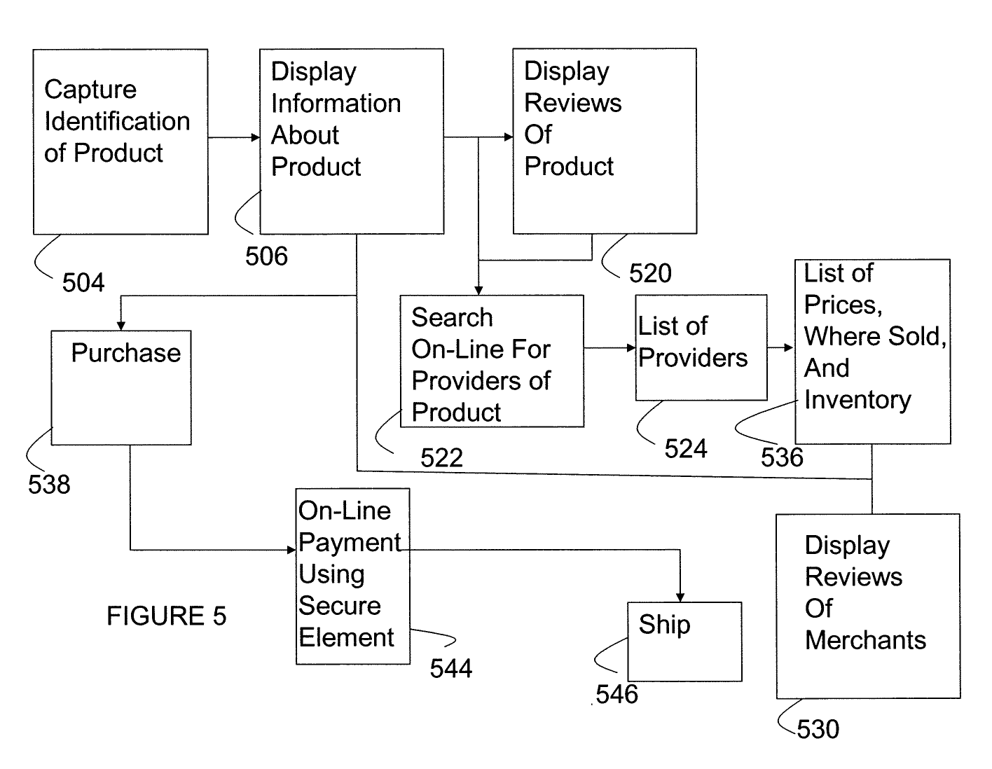

With reference to FIG. 5, mobile computing device 100 can be utilized in a process as follows: at a step 504, device 100 using camera can capture an image of a product such as by capturing its UPC code, receiving user input, other sensing techniques (e.g., radio frequency identifier technology), etc. In one example, the user can use device 100 to find a product on the Internet and select the product or obtain a product identity from a web site. The product identity can be a name, catalog number, UPC, etc. Alternatively, the product identity can be input using touch screen display 103, a keyboard or other user interface.

At a step 506, information about the product can be shown on display 102 of device 100. The information can include a display of reviews of product at a step 520. If the reviews of the product may interest the customer making the purchase, customer can advance to step 522 and search on-line for a list of providers of the product. Alternatively, after step 506, the customer can advance directly to a step 538 to make an on-line purchase of the product.

At a step 524, a list of product providers as well as providers of other products of similar interest can be provided. At a step 536, the list of merchants or providers associated with the product, the prices, the locations of sale, and inventory can be shown at a step 536. Alternatively, step 536 can directly follow step 522 and the list of merchants can be provided in step 536. At a step 530, reviews of merchants can be viewed on display 102.

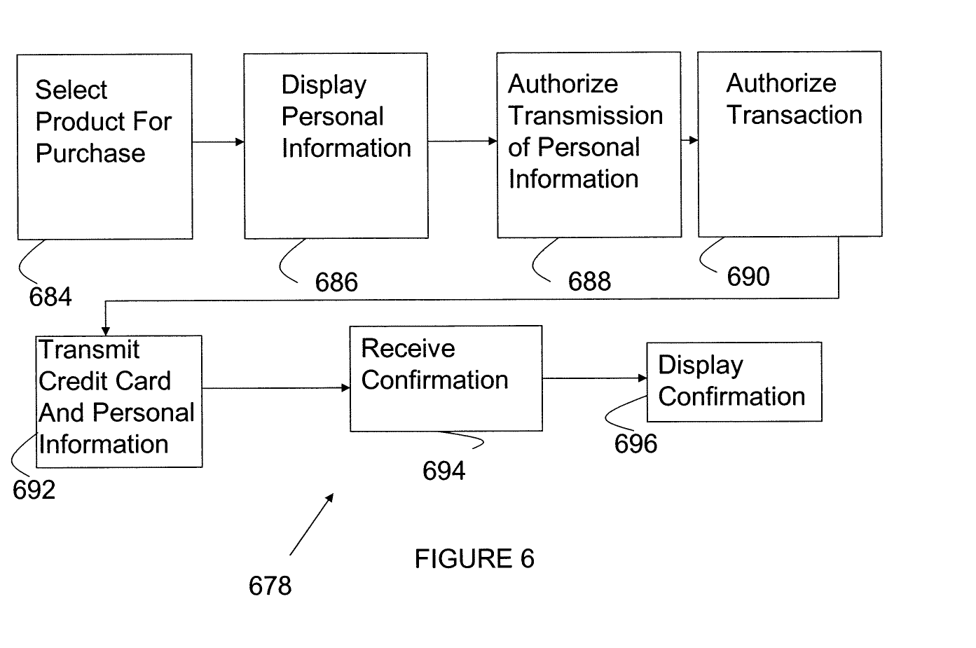

At step 538, the customer can determine to make an on-line purchase. At a step 554, the customer makes an on-line payment using secure element circuit 430. The secure element circuit 430 can be used to provide credit card information (or PayPal information) and/or personal information as described in more detail below with reference to FIG. 6. The customer can have the product shipped to an address at a step 546.

FIG. 6 is a block diagram showing an on-line payment process 678 that can be used in the process illustrated in FIG. 5 according to an exemplary embodiment. At a step 684, the customer selects a product for purchase. The product can be identified by a variety of techniques, including being manually input or via a web interface or using a UPC capture technique. At a step 686, personal information associated with the transaction is displayed. The personal information can include a delivery address for the product to be purchased. At a step 688, the user can authorize transmission of the personal information. At a step 690, the user can authorize the transaction. Steps 688 and 690 can be combined into one step if necessary to simplify process 678.

At a step 692, device 100 transmits credit card information using secure element circuit 430 and the personal information using secure element circuit 430 or other circuitry. Alternatively, the credit card information and personal information can be transmitted in separate steps. At a step 694, a confirmation of the transaction is received from the merchant. At a step 696, the confirmation is displayed.

In some embodiments, a credit card translator service may be provided to translate credit card data and/or personal information received at step 692 into a credit card number. In some technologies, certain credit card data cannot be read off a secure element, in a similar manner that a credit card number cannot be read by reading data from a magnetic strip of a credit card in some technologies. In such an embodiment, a computer server (e.g., operated by a credit card agency, third party translator, manufacturer of device 100, or other party) may be configured to receive certain credit card and/or personal information from device 100 and to translate that data or use it to look up a credit card number or other credit card or personal information needed to make a credit card transaction with a retailer. This translated information can then be sent by the server to the retailer and/or credit card company to help in completing the transaction.

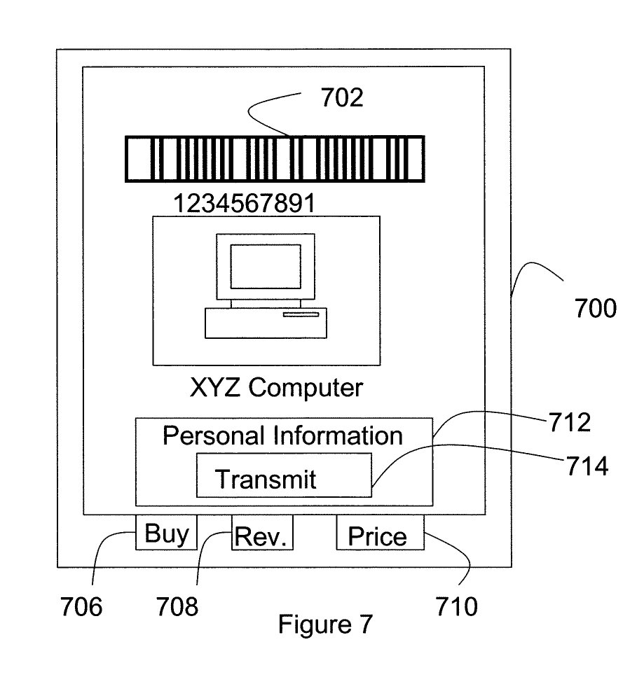

Referring to FIG. 7, a screen shot 700 for display on display 102 of device 100 is shown. Screen shot 700 shows a capture of a product code such as UPC symbol 702. Alternatively, the product code can be other identification (catalog number, product name, etc.) selected on the retailer's website. Screen shot 700 may also include a picture of the product and a product name or short product description. Screen shot 700 can also include an on-line purchase tab 706, a review tab 708, and a price tab 710.

Tab 106 advantageously provides access to one or more screens for making the on-line payment for the product, such as screen shot 700. Screen shot 700 can display personal information 712 and provide transmit button 714 for authorizing the transaction and or transmission of personal information. Alternatively, screen shot 700 can include an area for fingerprint identification or signature identification for such authorization.

Review tab 708 can provide the customer access to one or more review screens. The review screen can include reviews about the product as well as about merchants of the product. Price tab 710 can provide access to one ore more pricing screens. The pricing screen can include prices associated with each merchant. The pricing can include discount offers currently being offered for the customer. The pricing screen may include an interface for entering a reverse auction application where retailers provide bids on lowest prices for the product. Alternatively, other user interface means of accessing the various information associated with the retail transaction can be utilized. For example, icons, buttons, or other interfaces can be utilized to provide access to this instead of tabs 706, 708 and 710.

According to another embodiment, product comparison information may be provided on the pricing screen, the review information screen, or a fourth screen accessible similarly by a fourth tab (not shown). The product comparison information may provide information for a plurality of products of the same type or category as a product scanned by the user, which may be selected by the user or generated by the system based on a search of products of a similar type or category. A plurality of features of each product (e.g., price, customer reviews or ratings, reviews or ratings from critics or product evaluators, inventory status, specifications about the product, etc.) may be displayed as product comparison information.

Screen shot 700 may also include information about other purchases of the product, and products that those purchasers also purchased. For example, a list of accessories may also be provided that may be desired for purchase with the product.

The elements of data described above may each be stored in its own database, or may be grouped in any arrangement in one or more of databases created by device 100 and updated by device 100 from time to time as a user enters new data, downloads new applications, synchronizes with synchronization sources, configures new wireless configurations, etc.

The steps of FIG. 5 and 6 may be operable by one or more software modules executed on a mobile computing device 100 or server computer or computers having one or more data files. Device 100 may be configured to store the data files in memory, for example as firmware.

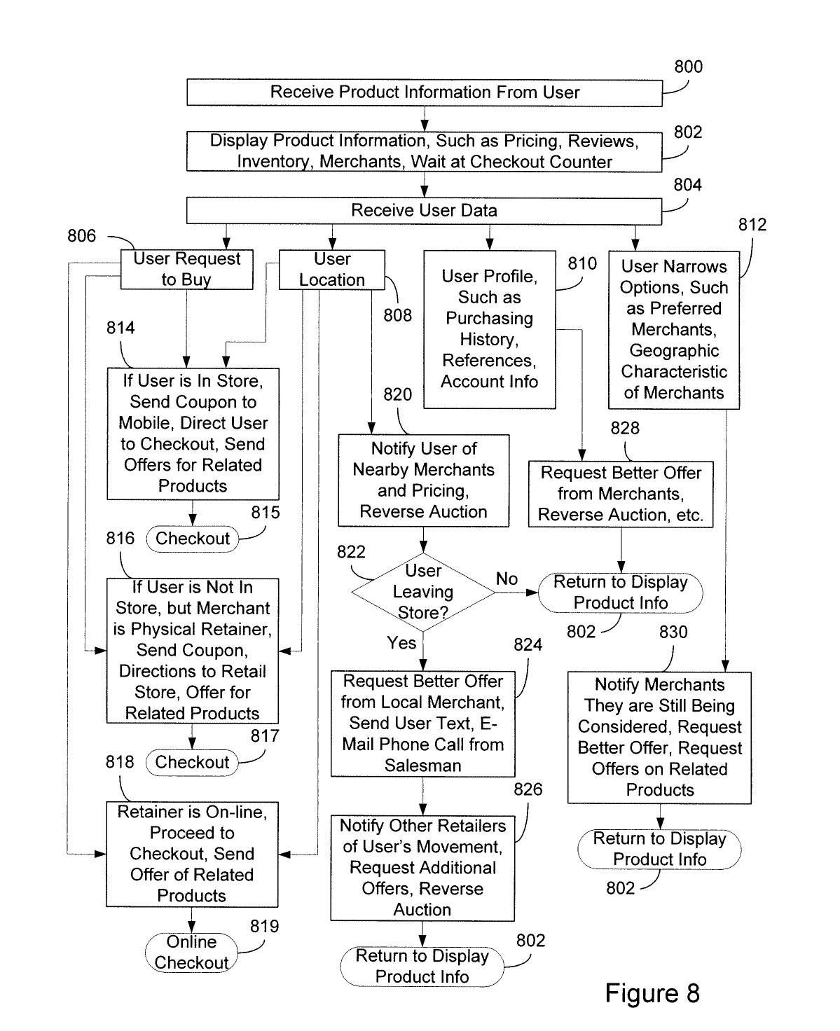

Referring now to FIG. 8, exemplary use scenarios for the systems and methods described herein will be described. At a step 800, mobile device 100 is configured to receive from the user and/or another source identification information sufficient to identify a product or products of interest to a user of device 100, such as a UPC capture, SKU number typed-in or spoken in to device 100, typed-in product name or model number, photograph of the product which can be used by a service professional at a remote location to identify the product, etc. At a step 802, additional information about the product is displayed or otherwise provided to the user of device 100. Device 100 may be configured to collect such information from one or more merchants, whether on-line or having a physical retail location. For example, device 100 may be configured to acquire a position fix from a location determination circuit and to identify retail locations in the vicinity of the user, for example, by using a geographic information database, such as one associated with Google Maps™ or other software application. Device 100 may be configured to communicate wirelessly, such as via a Wi-Fi network or via a cellular network or other wireless network in communication with the Internet, which provides access to a large number of merchants offering the product of interest for sale. Device 100 is configured to collect the product information from the various merchants either via software operable on device 100 or with the assistance of a server computer in wireless communication with device 100 at which the software is operable. Data such as pricing, product reviews, inventory status, merchant identification, and information about the merchant, such as whether a check-out counter at the merchant has a line and, if so, how long the wait will be, may be collected and provided to user device 100.

At step 802, device 100 or a server in communication with device 100 may be configured to operate a reverse auction, allowing different merchants to submit bids to the user for their business. The reverse auction operation may be configured to advise the various merchants of the lowest bid in order to encourage those merchants to make further lower bids and/or otherwise improve the offers made by providing additional products or services, improved delivery terms, such as free delivery, free related products, discounted related products, free warranty plans or discounted warranty plans, etc.

At step 804, mobile device 100 is configured to receive user data, which may comprise a request to buy a product (step 806), user location data from a location determination circuit on device 100 (step 808), user profile data (step 810), a request from the user to narrow the options available for purchasing a product (step 812), or other data related to the user or the user's device (e.g., PIM data, preferences, friend lists, presence indicators, etc.). At step 806, if the user has decided to make a purchase based on the product information displayed in step 802, if the user is in the store which sells the product, the process proceeds with step 814. At step 814, device 100 is configured to receive a coupon or other code indicative of the product and/or pricing for the product selected by the user based on the product information displayed in step 802. This data may be sent from a server computer associated with the physical store in which the user is located. Device 100 may be configured to receive a coupon in the form of a coupon code which can be read and spoken to a check-out person, or the coupon or purchase information can be provided in the form of a bar code which can be displayed on the display of device 100. In the latter case, device 100 can be scanned with a bar code scanner at a check-out terminal and a check-out terminal can receive information from the server regarding the purchase to provide the correct product, product code, and pricing associated with the transaction (e.g., winning bid in the reverse auction, etc.), and any applicable discounts to be applied at the check-out terminal. Payment may be received from the user in any form, such as cash, check, credit card, gift card, debit card. According to one advantageous embodiment, a secure element such as described herein with reference to FIG. 3 and FIG. 4 may be used along with a similar secure element or near field communication device in the check-out terminal in order to provide sufficient information about the user to the check-out terminal in order to complete the transaction. According to a further advantageous embodiment, use of the secure element to make the purchase can qualify the purchase for “card present” status, per a contractual arrangement between two or more of the merchant, the credit agency associated with the account used by the secure element, the manufacturer of device 100, or other parties.

Returning to step 814, device 100 may further be configured to receive offers for related products from a server associated with the merchant chosen by the user for the purchase. Device 100 can be configured to receive from the server a map of the store location, the position of user 100 in the store, and/or the position of the additional products to be found in the store to encourage and direct the user to walk over to the related products, take them from the shelf, and bring them along with any coupon or other offer stored on device 100 to the check-out terminal. The communications received by device 100 from the server associated with the store may be received via text message, e-mail, or any other electronic communication.

At a step 816, if the user has requested to purchase a product based on the information provided in step 802 from a different physical retailer than the retail location at which the user is currently located, a server computer associated with the retailer having the selected product may be configured to send a coupon or other product or pricing information and/or navigation directions to direct the user to the retail store, which may be in a nearby mall, or blocks or miles away. The directions may be provided in the form of a map, turn-by-turn audio directions or text directions, or any other format. Device 100 may further be configured to receive offers for related products available in that store. Alternatively, the system may comprise a server which is configured to report to the server associated with the retail location in which the user is located that the user has accepted a product offer from a separate retail location. In response, a server computer associated with the retailer at which the user is located may be configured to send a better offer (e.g., a lower bid) for the product purchased, offers for related products to the product to be purchased from the other retailer, etc. These offers may alternatively be provided by one or more on-line retailers. When the user arrives at the retailer associated with the product to be purchased, a check-out process 817 similar to that described above with reference to step 814 and 815 may take place.

At a step 818, when the user has requested to buy a product at step 806 and the retailer is an on-line retailer, the transaction can be completed using device 100, which may use any of the embodiments described herein or may use conventional embodiments for providing personal information, credit card information, shipping address, etc. into a web browser or other application interface on device 1 00. This information may be transmitted to a server computer associated with the on-line retailer from which the product is to be purchased. The on-line retailer may send offers for related products to the product being purchased to device 100 (at step 816), before the transaction is completed. A server computer may notify other on-line merchants or the retailer associated with the physical store in which the user is located to offer those parties another opportunity to provide a better price or better offer before the user finalizes the purchase with the selected on-line retailer. The reverse bidding or reverse auction process can continue. Step 819 illustrates an on-line check-out process, which may involve a shopping cart model, “one-click” model, or other on-line check-out model.

Returning to step 808, user location data may be received before, during, or after initial product information is displayed. This location data may be used at step 820 by a server computer to notify the user of nearby merchants and their associated pricing and/or to initiate a reverse auction or reverse bidding process. The bids or offers submitted by the other merchants, whether on-line or associated with a physical location or both, may be generated automatically without user input or with the assistance of a sales person or customer service person who is submitting bids based on information received about other bids from other on-line retailers or physical retailers, based on user profile or personal information, and/or other factors.

Step 822 represents a process operating to determine whether a user is moving toward an exit of a store, based on location data received from device 100 and a map of the store and exits associated with the store, or a more general map of the store and a parking lot near the store. If process 822 indicates that the user is moving toward an exit or about to leave a store, a computer associated with the local store in which the user is located may be requested by a device 100 or a server operating the program of FIG. 8 to provide a better offer to encourage the user to stay in the store and make the purchase. The better offer may comprise a better price, better financing, a deal on warranty, free products related or unrelated to the product, a membership or rewards card offer, or other offers or enticements. These offers may be offered by a server computer via text or e-mail or via a phone call from a live salesperson, or other mechanism. (Step 824). If the user is not leaving the store, product information is displayed again until the user has provided additional input or data. (Step 802, 804).

If the user has been enticed to remain in the store, the bidding process can continue by notification to other retailers, whether on-line or physical, of the user's movement and to request additional offers and continue the reverse auction process (step 826). This request for and/or receipt of other offers may be triggered by location data of the user, such as approaching an exit at the retail store, returning to the store, leaving the store, or using vehicle speeds after having been in or near a retail store. Once the additional bids or information or offers are received, they may be displayed along with any relevant product information and further data from the user is awaited (step 802, 804).

At step 810, after product information is received, additional user data may be received from device 100, such as a user profile, which may comprise a purchasing history, purchasing preferences, account information, address, affiliation, organization membership, similar products purchased by people in a friend list saved in device 100 or on a remote server, etc. User profile information can be used by device 100 or a server computer to request a better offer, a discount (e.g., AARP discount, AAA discount, American Bar Association discount, etc.) from one or more retailers offering sale of the product of interest (step 828). Once additional product offer information is received, it may be displayed at step 802 before additional user data is awaited at step 804.

At step 812, the user may be allowed via device 100 to narrow options, for example, limiting options to a certain price range, manufacturer, location, on-line versus physical, merchants in a preferred list of merchants, merchants shopped at frequently by individuals in a friend list stored on device 100, etc. At step 830, device 100 may be configured to notify merchants either directly or through use of the server that their products are still within the narrowed criteria provided by the user in step 812, at which time improved offers may be solicited or requested for the product of interest, related products, etc. The improved product information may be used to update the product information displayed at step 802 for review and potential selection by the user.

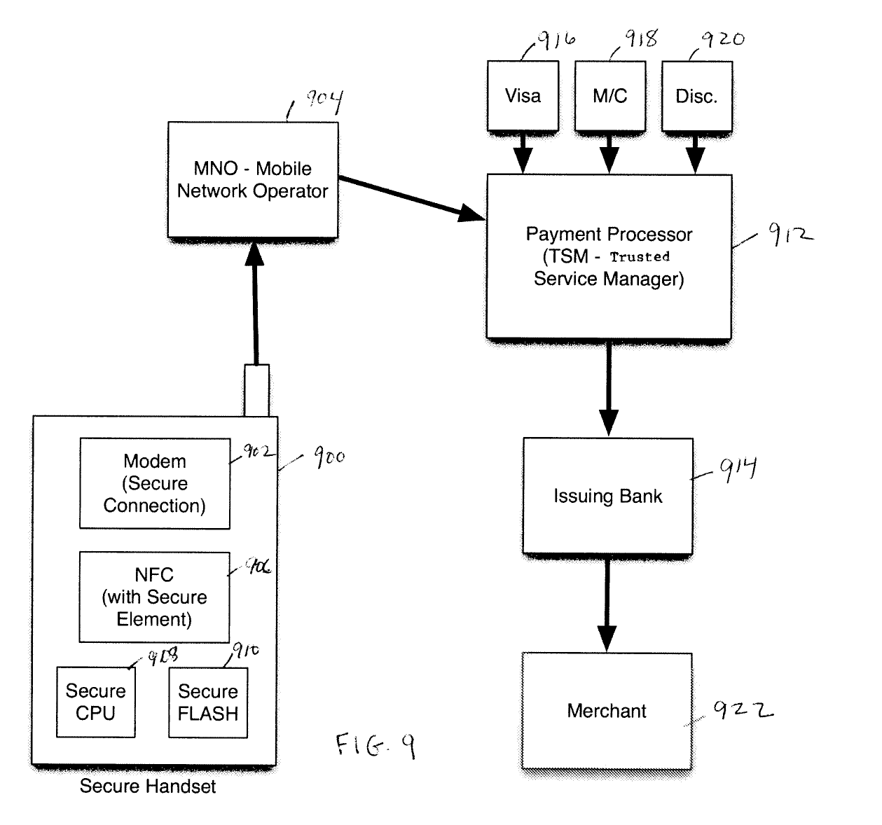

Referring now to FIG. 9, a secure handset 900 is shown. Handset 900 may comprise any of the components or aspects described herein, such as with reference to mobile computing device 100. Handset 900 may comprise one or more features designed to make the handset secure. A modem or wireless transceiver may be configured to establish a secure wireless communication session (e.g., using a Hypertext Transfer Protocol over Secure Socket Layer or https, or other secure protocol) with a mobile network operator 904 (e.g., a company and its associated equipment, such as cellular towers, server computers, etc. for providing wireless services to mobile phone user). A secure element 906, which may communicate via a Near Field Communication or other communication technology, may be provided which stores data about a user, such as user account data, such as a credit card number, name, credit card issuing company, etc.

In this embodiment, secure handset 900 comprises a secure processing circuit 908 which may operate one or more of a secure bootup sequence, a secure operating system, require security passwords for access, etc. For example, a secure processing circuit or secure CPU may be configured to validate a signature of a boot portion of a flash memory image to validate that the flash image is correct and the same as originally manufactured. A secure operating system may be configured to build upon the chain of trust that the secure boot establishes. A secure operating system may comprise code segments (including applications) that have been digitally signed by a trusted authority (e.g., VeriSign, Inc. of Mountain View, Calif.). In one embodiment, the processing circuit 908 may be configured to disable access to one or more predetermined features (e.g., access to data stored on secure element 906) if a second operating system is loaded onto handset 900 after manufacture. Secure processing circuit 908 may be configured to implement one or more user authorization techniques, such as a biometric mechanism (e.g., fingerprint scanner, retinal scanner, vein pattern recognizer, voice recognizer, etc.), username/password receipt, etc. Secure handset 900 further comprises a secure memory 910, which may comprise flash memory or other memory types. A secure flash memory may comprise a secure partition on a memory device which uses encryption to store the data. Using one or more of the above-referenced security aspects, it may be determined by a payment processor 912 and/or issuing bank 914 that handset 900 is sufficiently secure for one or more purposes, such as processing a transaction requested by handset 900, giving “card present” or other status to the requested transaction, shifting liability for a fraudulent transaction from the merchant to a credit issuing agency, or for other purposes. For example, providing one or more of the above-referenced security aspects on handset 900 may make handset 900 substantially as secure as a point of sale terminal.

In this embodiment, a payment processor 912 is used to facilitate a transaction. Payment processor 912 may comprise one or more server computers (e.g., processing circuits) operated by an entity tasked with processing a payment, such as a trusted service manager. Examples of services offered by trusted service managers include the MIFARE service offered by NXP Semiconductors, The Netherlands, a TSM service offered by CASSIS International Pte Ltd., Singapore, a TSM service offered by Venyon Oy, Helsinki, Finland, and ViVOtech, Inc., Santa Clara, Calif. Payment processor 912 may be operated under contract to process transactions requested by handset 900 from one or more credit account issuing companies, such as Visa 916, Mastercard 918, Discover 920, etc. Payment processor 912 may be configured to receive the transaction request from device 900 via MNO 904, to determine account numbers and other data needed to process the transaction, and to send a request to an issuing bank 914 to pay an account in the name of a merchant 922 associated with the transaction request. Transaction authorization may be provided by payment processor 912 and issuing bank 914. Merchant authorization may be provided by payment processor 912 and the appropriate credit account issuing company 916-920.

According to one embodiment, secure element 906 may be configured to hold account data for a plurality of credit accounts in the name of a user of handset 900. Secure element 906 may be configured to provide a default from among the plurality of credit accounts. When a user wishes to make a transaction, processing circuit 980 sends a message to secure element 906 to request transmission of account data. Secure element 906 may send the account data (along with other data regarding the requested transaction) over the secure connection 902, through MNO 904 to payment processor 912. The account data may be the default account data. Alternatively, processing circuit 908 may send a message (e.g., but running a secure application or otherwise) to secure element 906 to identify one of a plurality of sets of account data to send, or to change the default account. In one embodiment, account data stored within secure element is not readable by processing circuit 908 (though the name of the credit account issuing company 916-920 may be readable). In another embodiment, data stored on secure element 906 may be accessible or readable by processing circuit 908, in view of the presence of one or more of the security mechanisms associated with processing circuit 908, memory 910 and wireless transceiver 902 which server to protect data stored on secure element 906.

The embodiments disclosed herein have been described with reference to block diagrams and flow diagrams. Each block may represent one or more computer programs (e.g., software, firmware, etc.) and/or the hardware or processing circuitry on which the computer programs operate (e.g., microprocessors, microcontrollers, application-specific integrated circuits, programmable logic, programmable gate array, etc.). Use of the term module herein may refer to either computer program and/or circuit components operating the computer program to carry out the functions described herein. Modules may interface with other modules at a hardware and/or computer program level, and may operate at and/or interface with other modules at any applicable computer program level specified in the Open Systems Interconnection (OSI) model, such as application layer, presentation layer, session layer, transport layer, network layer, data link, physical layer, etc. Modules may be represented by a block, multiple blocks or portions of blocks in the various figures herein.

While the exemplary embodiments illustrated in the FIGS, and described above are presently exemplary, it should be understood that these embodiments are offered by way of example only. Accordingly, the present invention is not limited to a particular embodiment, but extends to various modifications that nevertheless fall within the scope of the appended claims.

What is claimed is:

1. A mobile computing device, comprising:
a display;
a storage medium for storing a secure element for transactions; and
a processing circuit configured so that a user can purchase the product from an on-line merchant to make an on-line payment.

2. The device of claim 1, wherein the processing circuit is configured to communicate with a transaction system of the on-line merchant, wherein the processing circuit provides credit card information to the transaction system.

3. The device of claim 2, wherein the processor also provides personal information to the transactions system.

4. The device of claim 2, wherein the credit card information includes a credit card number and a date of expiration.

5. The device of claim 4, wherein the credit card information includes a card verification number.

6. The device of claim 5, wherein the personal information includes address information.

7. The device of claim 1, wherein the processing circuit is configured for a secure web-based communications connection.

8. The device of claim 1, wherein the use of the secure element allows the transaction to be a card present status transaction.

9. The device of claim 1, wherein the processing circuit provides reviews of the merchants.

10. The device of claim 1, wherein the device includes cellular telephone capabilities.

11. The device of claim 1, wherein the device further comprises a near field communication system for transactions using a point of sale device.

12. A method of purchasing a product using a mobile computing device, the method comprising:
providing secure element data to an on-line merchant or agent thereof, thereby obtaining card present status for an on-line transaction, the secure element data being stored in storage associated with the mobile computing device; and
providing an on-line payment screen for the on-line store or providing an indication of a discount for a purchase in the physical store.

13. The method of claim 12, wherein the on-line payment screen includes personal information.

14. The method of claim 12, wherein the personal information includes an address.

15. The method of claim 12, wherein the secure element is stored on a memory card.

16. The method of claim 12, wherein the secure element stores credit card information.

17. A mobile computing device, comprising:
a display; and
a processing circuit configured to provide an image to the display, wherein the image includes an interface allowing the user to make an on-line purchase, the processing circuit configured to provide credit card information stored on a secure element for the on-line purchase.

18. The mobile computing device of claim 17, wherein the secure element is stored on a removable device for use in the mobile computing device.

19. The mobile computing device of claim 18, wherein communication for the on-line purchase is a secure web communication.

20. The mobile computing device of claim 18, wherein the mobile computing device includes cellular phone capabilities.
